(19) United States
(12) Patent Application Publication
(10) Pub. No.: US 2005/0256702 A1
(43) Pub. Date: Nov. 17, 2005

(54) Algebraic codebook search implementation on processors with multiple data paths

(75) Inventor: Sarat Chandra Vadapalli, Bangalore (IN)

Correspondence Address: Global IP Services, PLLC;c/o PortfolioIP, P.O. Box 52050, Minneapolis, MN, 55402, US

(73) Assignee: Ittiam Systems (P) Ltd.

(21) Appl. No.: 11/127,715

(22) Filed: May 12, 2005

Related U.S. Application Data
(60) Provisional application No. 60/570,708, filed on May 13, 2004.

(51) Int. Cl. G10L 19/12

(52) U.S. Cl. 704/223

(57) ABSTRACT

A method for codebook search in an algebraic code-excited linear prediction (ACELP) encoder is implemented with a multiple data path processor. The invention is particularly applicable in speech coders based on the ITU standards G.729 and G.723.1, and as applied to GSM adaptive multi-rate WB. Processors with multiple data paths are used efficiently in the present invention, whereby the inner loop search is faster. Pulse positions over which the codeword search is done are expediently grouped into subsets, and the search conducted using the processor parallel data paths. The number of pulses and the number of loops can be four, or chosen as desired. The codebook search expediently includes a second step of conducting a search among the best pulse positions corresponding to the innermost loop to arrive at a final best position.

### RELATED APPLICATIONS

Benefit is claimed under 35 U.S.C. 119(e) to U.S. Provisional Application Ser. No. 60/570,708, entitled “Efficient Implementation of Algebraic Codebook Search on Processors with Multiple Data Paths” by Sarat C. Vadapalli, filed May 13, 2004, which is herein incorporated in its entirety by reference for all purposes.

### FIELD OF THE INVENTION

This invention generally relates to the implementation of the Algebraic Codebook search in speech coders using Algebraic Code Excited Linear Prediction (ACELP) technique, and more particularly to the implementation of the same on processors with multiple data paths.

### BACKGROUND OF THE INVENTION

Speech compression is widely known for handling speech signals and is governed by standards and available speech and audio coding algorithms. CELP is known as an efficient closed loop analysis-by-synthesis (Abs) method for narrow and medium band speech coding systems. It is known that speech compression technology provides reduced operating costs in voice communications. Speech coders may generally be either (i) Waveform coders (operating at high bit rates and producing good quality speech), and (ii) Parametric coders (operating at low bit rates and producing synthetic quality speech). Vector quantization (VQ) is a compression method associated with some loss and based on the principle of parametric coding. VQ is a potentially efficient representation of spectral information in the speech signal. The idea of VQ is to take blocks of source outputs (vectors) of length “n” and map them into a finite set “C” (in “n” dimensional Euclidian space) containing “K” output or reproduction points called code vectors or code words. The set “C” is known as the codebook and has size “K”, meaning that it has “K” distinct elements. The encoder is required to select the binary codeword which when decoded yields a reproduction with minimum distortion of the input with respect to all possible reproductions. It is also noted that excitation for the speech signal may be computed per 5 ms sub-frames and can have two components: fixed and adaptive codebook. Coders may also be the time-domain type, performing the coding process on time samples of signal data. Coding methods in time domain include PCM (pulse code modulation) and adaptive PCM (APCM), delta modulation (DM), adaptive DM (ADM), and adaptive predictive coding (APC). Most low bit rate high quality speech coders are based on linear predictive coding ((LPC) analysis that models speech signal as a linear combination of past and present values of a hypothetical input to a system whose output is a given signal. For speech, it is known that prediction is a combination of short term prediction and long term prediction. For additional background information, reference may be had to the publication Voice Compression and Communications, Principles and Applications for Fixed and Wireless Channels, in IEEE Series on Digital and Mobile Communication.

The standard G.729 (which follows conjugate structure algebraic CELP), is based on the human speech model where the throat and mouth have the function of a linear filter with an excitation vector. For each frame in G.729, an encoder analyses input data and extracts the parameters of the CELP model such as linear prediction filter coefficients and the excitation vectors (-analysis by synthesis method-). The encoder searches through its parameter space, carries out the decode operation in each loop of the search and compares the output signal of the decode operation (synthesis signal) with the original speech signal.

In certain CELP coders, speech is segmented into frames (10-30 ms long) and for each frame, an optimum set of linear prediction and pitch filter parameters are determined and quantized. Each speech frame may be further divided into a number of sub-frames (typically 5 ms), and for each sub-frame, an excitation codebook is searched to find the input vector to a quantized predictor system that gives the best reproduction of the speech signal. In general, the reproduction accuracy improves with increasing excitation codebook size, and when the codebook population is a better approximation of the speech excitation distribution. Mean squared error is an accepted measure of control and quality, and is sometimes referred to as mean square deviation in statistical process control.

The standard G.723.1 specifies coding schemes that compress speech signal sampled at 8 kHz to either 5.3 or 6.3-KBPS. The lower-bit-rate coder uses “algebraic-code-excitation linear prediction” (ACELP) as the coding scheme; the higher-bit-rate coder uses “multi-pulse maximum-likelihood excitation” (MP-MLQ). Each coder is designed to process frames of 240 samples, or 30-milliseconds of speech data. It is possible to switch between the two rates on any 30-msec frame boundary.

Typical CELP speech codecs use the LPC source-excitation model and the “Analysis by Synthesis” (Abs) codec structure to compress the speech signal. In this model, the speech generation is modeled using a synthesis filter. The synthesis filter is typically a combination of the: (1) Short-term Synthesis filter, which takes care of the Short time Prediction; (2) Long-term Synthesis filter, which takes care of the Long-term prediction. In Abs coders, each candidate excitation vector is used to excite the synthesis filter. The difference between the “input signal” and the output of the synthesis filter (“predicted signal”) is the “error signal”. This “error signal” is perceptually weighted to take care of the perceptual irrelevancies. The specific excitation vector, which minimizes the “perceptually weighted error”, is deemed to produce the best synthetic quality. Vector quantization techniques are used to quantize and code the excitation vector.

In CELP coders, a codebook of excitation vectors is maintained and the error minimization algorithm is used to choose the best excitation vector. In Forward-Adaptive CELP codecs, the excitation signal u(n) is given by the sum of outputs from two codebooks. The adaptive codebook is used to model the long-term periodicities present in the voiced speech and the fixed codebook models the random noise-like residual (unvoiced) signal that remains after short-term and long-term prediction.

### SUMMARY OF THE INVENTION

One embodiment of the invention resides in a method for performing a codebook search in an algebraic codebook-based coder in an algebraic code excited linear prediction (ACELP) encoder using multiple parallel data paths, comprising the steps of: using a nested loop structure and as many loops as there are pulses, said loop structure including an innermost loop; increasing efficiency of the innermost loop by grouping valid pulse positions into subsets; and, selecting a best pulse position from each of said subsets to find a most beneficial code vector for performing the codebook search. A second embodiment of the invention resides in a method for performing a fixed codebook search in an algebraic code-excited linear prediction (ACELP) encoder using a processor with multiple parallel data paths, comprising the steps of: using a nested loop structure and as many loops as there are pulses, said loop structure including an innermost loop; increasing efficiency of the innermost loop by grouping valid pulse positions into subsets and using said multiple data paths; selecting a best pulse position from search in each of said subsets to find a most beneficial code vector for performing the codebook search, the method including conducting a second search among best pulse positions corresponding to the innermost loop to arrive at a final best position, further including the step of reducing time required for executing said innermost loop. Further embodiments of the invention reside in articles including a computer readable medium having a program thereon which when executed results in a method as recited above. The technique of the invention can be used in conjunction with any kind of processor. However, there are distinct advantages to using processors with parallelism, especially processors with multiple data paths in the context of the invention. The invention has application in any system where ACELP is used. Specifically, the invention is useful for implementation in standards ITU-T G.729, ITU-T G.723.1 and in GSM-AMR.

### BRIEF DESCRIPTION OF THE DRAWING

FIG. 1 is a diagrammatic illustration of a forward adaptive Abs CELP speech encoder;

FIG. 2 is a more detailed illustration of a forward adaptive Abs CELP speech encoder;

FIG. 3 is a diagrammatic illustration of an exemplary processor with multiple data paths, that can be used in the implementation of the invention; and,

FIG. 4 illustrates a general purpose computing set up that can be used in the implementation of this invention.

### DETAILED DESCRIPTION OF EMBODIMENTS

In the following detailed description of the various embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is therefore not to be taken in a limiting sense, and the scope of the present invention is defined only by the appended claims.

The present invention is applicable, without limitation, to any speech coder, and specifically to a speech coder using algebraic CELP. Also, the present invention is capable of implementation in any scenario where the processor in use has multiple data paths. More specifically, the invention is applicable in speech coders based on the ITU (International Telecommunication Union) standards G.729 and G.723.1. Processors with multiple data paths are used efficiently using the present invention, whereby the search is faster. The pulse positions over which the codeword search is done are expediently grouped into subsets, and the search conducted using the parallel data paths of the processor. Thus, the innermost loop search is made more time efficient. For purposes of illustration only and not as a limitation, the invention is described in a fixed codebook search scenario wherein there are four loops and four pulses, the search being done using a processor with two data paths as an example. To reduce processing time, the search operation in the innermost loop is expediently broken down into two divided parallel search operations, before arriving at a best pulse position. The number of pulses and the number of loops can be chosen as desired, and any processor having multiple data paths can be used for implementing the invention.

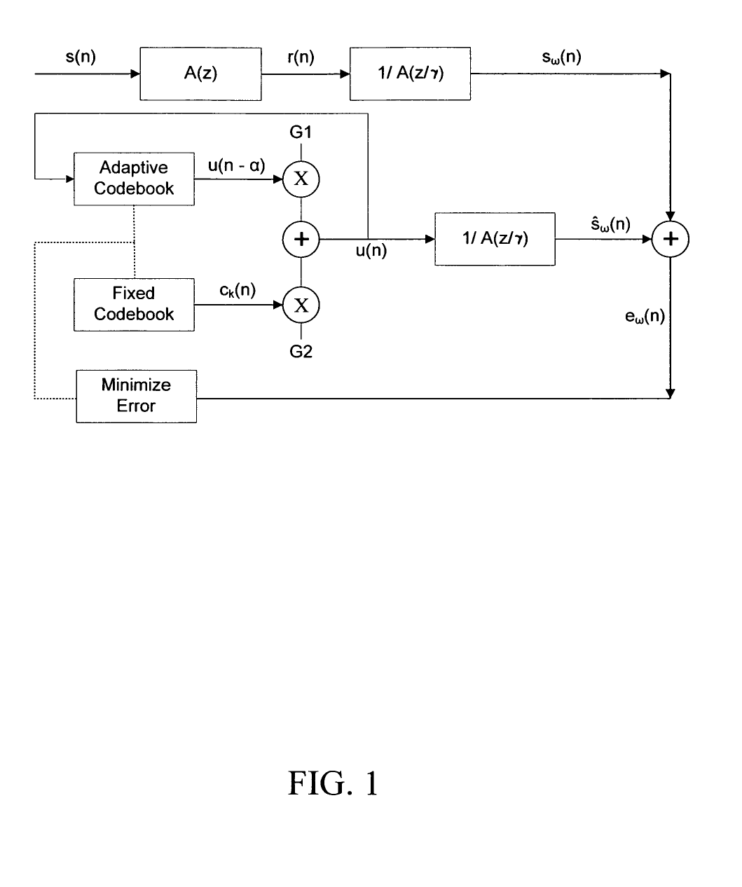

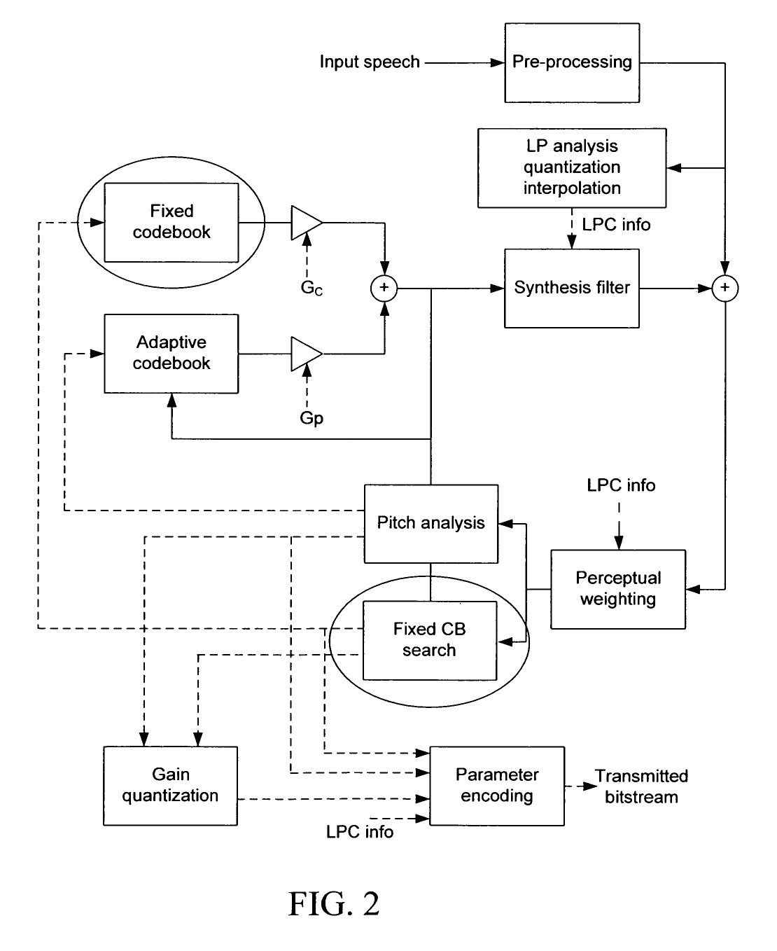

FIG. 1 illustrates a diagrammatic representation of a forward adaptive Abs CELP speech encoder showing an incoming speech signal, an adaptive codebook, fixed codebook and an error minimizing block that receives the perceptually weighted error signal e_{w}(n). FIG. 2 illustrates a more detailed diagram of the components of FIG. 1, showing the pre-processing block, LP (linear prediction) analysis quantization interpolation, synthesis filter, fixed and adaptive codebooks, Pitch analysis, perceptual weighting, fixed codebook search, gain quantization, parameter encoding, and finally the transmitted bit stream. FIGS. 1 and 2 are derived from the ITU-T G 729 standard based on conjugate symmetric-algebraic CELP encoder. Further details of the components illustrated in FIGS. 1 and 2 will be intelligible to those who are conversant with the speech coder standards and are skilled in the art.

Fixed Codebook Search:

Fixed codebook search involves the process of finding the index of the excitation vector which minimizes the perceptually weighted error e_{w}(n) for the frame of speech data being compressed.
(For all the variables in the equations refer FIG. 1)

$$\begin{matrix}{e}_{w} ( n ) = {s}_{w} ( n ) - {s}_{w}^{′} ( n ) \\ = {s}_{w} ( n ) - ( adaptive codebook contribution ) - {G}_{2} ( {c}_{k} ( n ) * h ( n ) ) \\ = {x}^{′} ( n ) - {G}_{2} ( {c}_{k} ( n ) * h ( n ) )\end{matrix}$$

In the above equations,
s_{w}(n)→perceptually weighted input speech
s′_{w}(n)→perceptually Weighted Reconstructed Speech
G₂→Gain corresponding to the fixed codebook excitation vector
cₖ(n)→Excitation codeword from the fixed codebook
h(n)→Impulse response of the weighted synthesis filter (used in codebook search)
x′(n)→Referred to as the Target Vector (for Fixed Codebook search).
Though the finer details of the filters and their topologies of the encoders change across many coders, the process of fixed codebook search in CELP coders usually deals with the minimization/reduction of the perceptually weighted error e_{w}(n). Reducing/minimizing the Mean Squared Energy of the error e_{w}(n), it can be proved that the most desirable/optimal code vector is the one which increases/maximizes the term Tₖ,

$$where {T}_{k} = \frac{{C}_{k}^{2}}{{ξ}_{k}} , where$$

$${C}_{k} = {\sum }_{n = 0}^{N - 1} ψ ( n ) {c}_{k} ( n )$$

where N is the length of the frame being compressed, and,

$${ξ}_{k} = {\sum }_{n = 0}^{N - 1} {[ {c}_{k} ( n ) * h ( n ) ]}^{2} , and , \\ ψ ( i ) = {\sum }_{n = 0}^{N - 1} [ {x}^{′} ( n ) h ( n - i ) ]$$

Physically, Cₖ is the correlation between the filtered codeword and the target vector and ξₖ is the energy of the filtered codeword.

Algebraic CELP:

In ACELP coders, the codebooks have an Algebraic structure. The analysis frame of data is made smaller (typically 5 ms-7.5 ms). Hence, the search is done for every sub-frame. Each excitation codeword has only a fixed (typically 4 or 5) number of pulses, which have amplitudes +1 or −1. Also, each non-zero pulse has a limited number of positions where it can lie.

In ITU-T G.729 codec:

Number of pulses=4
Length of the CodeVector=Length of the Sub-frame=5 ms (40 samples)
   In ITU-T G.723.1A codec:
Number of pulses=4

Length of the CodeVector=Length of the Sub-frame=7.5 ms (60 samples)

TABLE 1
Structure of ACELP codebook in ITU-T G.729

| Pulse (j) | Sign | Allowed Positions | |
|---|---|---|---|
| 0 | s0: ±1 | m0: | 0, 5, 10, 15, 20, 25, 30, 35 |
| 1 | s1: ±1 | m1: | 1, 6, 11, 16, 21, 26, 31, 36 |
| 2 | s2: ±1 | m2: | 2, 7, 12, 17, 22, 27, 32, 37 |
| 3 | s3: ±1 | m3: | 3, 8, 13, 18, 23, 28, 33, 38 |
| | | | 4, 9, 14, 19, 24, 29, 34, 39 |

The structure of the ACELP codebook used in ITU-T G.729 is shown in Table 1 above. Each pulse j can take amplitude of +1 or −1 and any of the positions mⱼ.

If the number of pulses is M and the length of the sub-frame being compressed is N, then we can express Cₖ and ξₖ as

$${C}_{k} = {\sum }_{i = 0}^{M - 1} {s}_{i} ψ ( {m}_{i} )$$

$${ξ}_{k} = {\sum }_{i = 0}^{M - 1} ϕ ( {m}_{i} , {m}_{i} ) + 2 * {\sum }_{i = 0}^{ M - 2} {\sum }_{j = i + 1}^{M - 1} {s}_{i} {s}_{j} ϕ ( {m}_{i} , {m}_{j} ) ,$$

where mᵢ is the position of the i^{th} pulse and sᵢ is the sign of the i^{th} pulse
   Standard Techniques used in the Fixed Codebook search of ACELP coders:
1. The amplitude of the pulses at each of the positions is pre-decided based on the sign of the filtered codeword ψ( ) at that position. This results in the generation of the modified ψ( ) and φ( ) functions (i.e. ψ′( ) and φ′( )) in which the sign information is embedded.
2. Nested loops are used with each of the excitation pulses. If the number of pulses is 4, then by changing only one pulse at a time, Cₖ and ξₖ can be computed efficiently using 4 nested loops associated with the 4-excitation pulses. In the innermost loop, Cₖ is updated with one addition and ξₖ with 3 multiplications and 4 additions;
3. Threshold is applied on the intermediate sums of Cₖ to reduce the number of search iterations. (Intermediate sum is the value with only 3 pulses used i.e., the value computed in the 3^{rd} loop and sent to the innermost loop)
Using step1 of the above:

$${C}_{k} = {\sum }_{i = 0}^{M - 1} {ψ}^{′} ( {m}_{i} )$$

$${ξ}_{k} = {\sum }_{i = 0}^{M - 1} {ϕ}^{′} ( {m}_{i} , {m}_{i} ) + 2 * {\sum }_{i = 0}^{M - 2} {\sum }_{j = i + 1}^{M - 1} {ϕ}^{′} ( {m}_{i} , {m}_{j} )$$

A specific example of the steps for performing an inner loop search in prior art is as follows:

In this example, the Fixed Codebook Search in ACELP coders involves finding the positions of the pulses among the available positions in the codebook such that (Cₖ*Cₖ/ξₖ) is increased/maximized.

Pseudo-search algorithm for ACELP codebook:

```
Initialize Kopt
For m0 = all valid positions of m0
      Set Cₖ and ξₖ to 0
      Update Cₖ and ξₖ with contribution of m0 as
      (Cₖ, ξₖ) (m0) = contribution of m0
      For m1 = all valid positions of m1
            Update Cₖ and ξₖ with contribution of m1 as
            (Cₖ, ξₖ) (m0, m1) = (Cₖ, ξₖ) (m0) + contribution of m1
            For m2 = all valid positions of m2
                  Update Cₖ and ξₖ with contribution of m2 as
                  (Cₖ, ξₖ) (m0, m1, m2) = (Cₖ, ξₖ) (m0, m1) +
                  contribution of m2
                  Run: Innermost Loop
            End for
      End for
End for
Innermost Loop
For m3 = all valid positions of m3
      Update Cₖ and ξₖ with contribution of m3 as
      (Cₖ, ξₖ) (m0, m1, m2, m3) = (Cₖ, ξₖ) (m0, m1, m2) +
      contribution of m3
      If (Cₖ²ξ_{Kopt} − C_{Kopt}²ξₖ) ≧ 0 Then Kopt =
      (m0, m1, m2, m3)
End for
```

In spite of the standard optimizations listed in the above example, codeword search is computationally intensive and takes many clock cycles. The innermost loop needs to be executed for each combination of (m0, m1, m2). Hence, the efficiency of the search process depends primarily on the time taken for the execution of the innermost loop.

Even on VLIW (very long instruction word) processors, the benefit of parallelism and pipelining cannot be completely gained because of the limited number of operations and data dependency in the actual search operation. The condition to update Kopt in the pseudo-algorithm imposes a dependency and thus affects the pipelining.

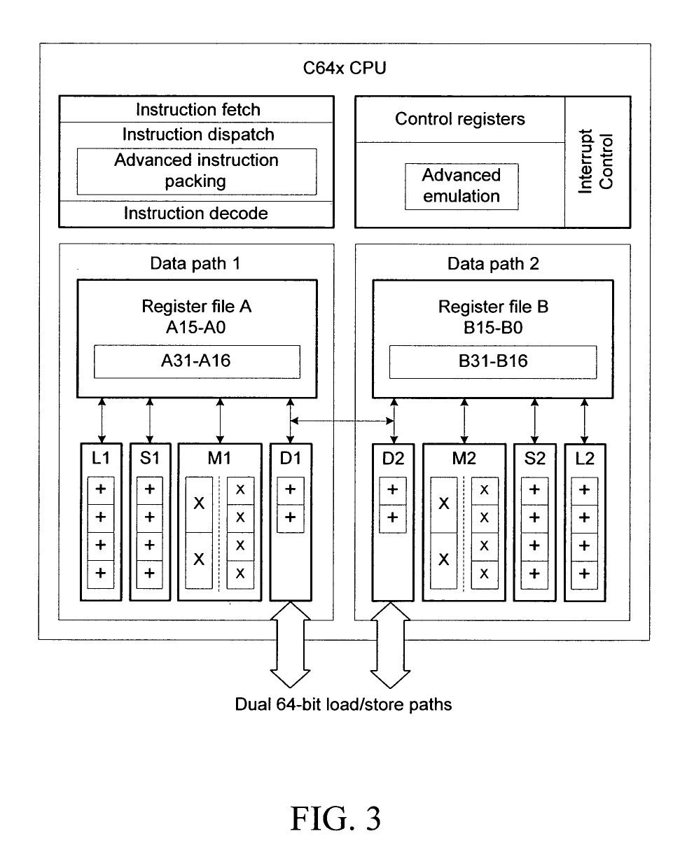

FIG. 3 illustrates a TMS320C64X processor as an example of a multi data path processor that could be used in implementing the present invention for performing the fixed codeword search for ACELP coders. More specifically, the illustrated TMS320C64X processor has 2 data paths. Each data path is connected to identical processing blocks containing 4 functional units and 1 register file (32 registers). Each functional unit is capable of executing one instruction in 1 clock cycle using registers in the same data path. It is to be understood that any other processor that has multiple data paths may be used instead, without any limitation.

In order to reduce the impact of the data dependency on the time taken by the search operation, the search operation is implemented as stated in the following steps:
1. Segment the Set Spos equally into smaller sets Spos1 and Spos2
2. Run the innermost Search loop over Spos1. Find the optimal pulse position for m3 among Spos1, say Kopt1
3. Run the innermost Search loop over Spos2. Find the optimal pulse position for m3 among Spos2, say Kopt2 (Steps 2 and 3 can be executed in parallel with two data paths, e.g., on TMS320C64X processor. Step1 will use ‘Datapath1’ and step2 will use ‘Datapath2’)
4. Choose Kopt between Kopt1 and Kopt2, using thefollowing algorithm
   If (C_{Kopt1}²ξ_{Kopt2}−C_{Kopt2}²ξ_{Kopt1})≦0

Then
Kopt=Kopt1

Else
Kopt=Kopt2

It is noted that the search across all available positions of m3 is broken into 2 search operations among smaller sets of half the size. These searches are done in parallel. Though the number of search operations has not reduced the amount of time required for executing the innermost loop has reduced considerably.

If the number of available positions for m3 is 2P, then P positions are each grouped into Subset 1 and subset 2:
1. Number of search operations in the innermost loop=(2P+1). (P in Step2+P in Step3+1 in Step4)
2. Number of search cycles (i.e. time required)=(P+1) search-cycles. (P for Steps2 and 3+1 for Step 4)

Alternatively, to further reduce the processing time, Step 4 can be executed after exiting completely from all the four loops. This would reduce the number of search operations in the innermost loop to 2P and the number of search cycles to P.

Pseudo-Code describing an exemplary Final Algorithm:

Assuming L data paths, 4 pulse positions, Spos→Set of available Pulse positions for m3.

```
Start of Search
1. Segment Spos into sub-sets of equal size→ {Spos1, Spos2, . .. .. ,
SposL }
2. Initialize Kopt1, Kopt2, ... KoptL
3. Run the Loops:
For m0 = all valid positions of m0
      Set Cₖ and ξₖ to 0
      Update Cₖ and ξₖ with contribution of m0 as
      (Cₖ, ξₖ) (m0) = contribution of m0
      For m1 = all valid positions of m1
            Update Cₖ and ξₖ with contribution of m1 as
            (Cₖ, ξₖ) (m0, m1) = (Cₖ, ξₖ) (m0) + contribution of m1
            For m2 = all valid positions of m2
                  Update Cₖ and ξₖ with contribution of m2 as
                  (Cₖ, ξₖ) (m0, m1, m2) = (Cₖ, ξₖ) (m0, m1) +
                  contribution of m2
                  Run in parallel: Innermost Loops over
                  Spos1, , ... SposL
                  This step updates Kopt1, Kop2, ... KoptL
            End for
      End for
End for
4. Search for the optimal codeword among Kopt1, Kop2, ... KoptL
End of Search
Innermost Loop over Sposj
For m3 = all elements in Sposj
      Update Cₖ and ξₖ with contribution of m3 as
      (Cₖ, ξₖ) (m0, m1, m2, m3) = (Cₖ, ξₖ) (m0, m1, m2) +
      contribution of m3
      If (Cₖ²ξ_{Koptj} − C_{Koptj}²ξₖ) ≧ 0 Then Koptj =
      (m0, m1, m2, m3)
End for
```

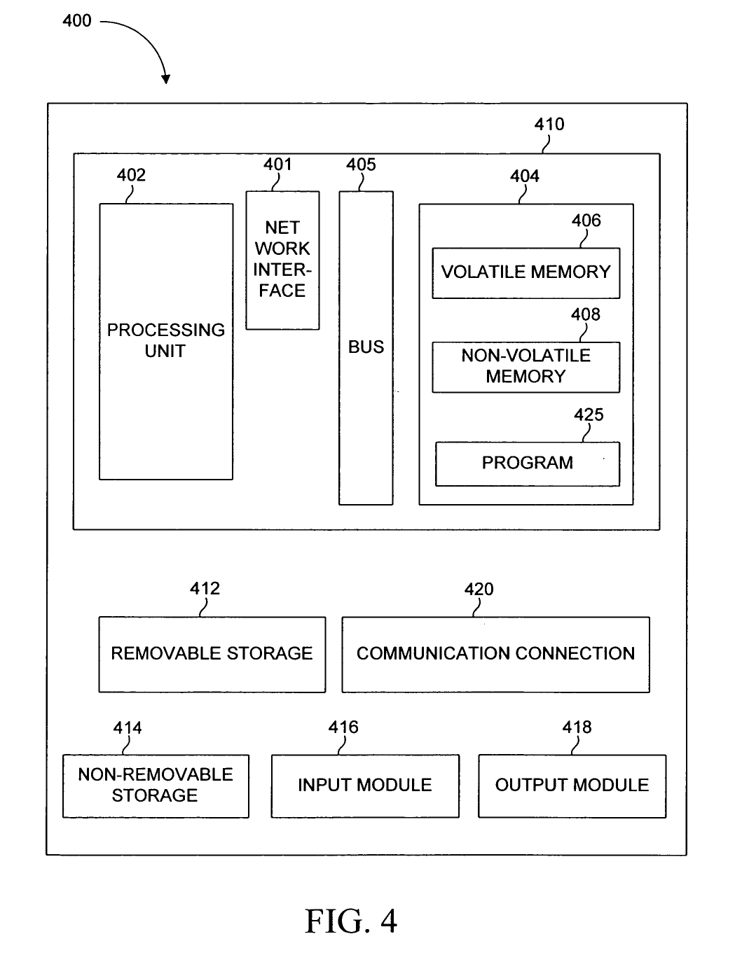

Various embodiments of the present subject matter can be implemented in software, which may be run in the environment shown in FIG. 4 or in any other suitable computing environment. The embodiments of the present subject matter are operable in a number of general-purpose or special-purpose computing environments. Some computing environments include personal computers, general-purpose computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments and the like to execute code stored on a computer-readable medium. It is also noted that the embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

FIG. 4 shows an example of a suitable computing system environment for implementing embodiments of the present subject matter. FIG. 4 and the following discussion are intended to provide a brief, general description of a suitable computing environment in which certain embodiments of the inventive concepts contained herein may be implemented.

A general computing device in the form of a computer 410 may include a processing unit 402, memory 404, removable storage 412, and non-removable storage 414. Computer 410 additionally includes a bus 405 and a network interface (NI) 401.

Computer 410 may include or have access to a computing environment that includes one or more user input devices 416, one or more output modules or devices 418, and one or more communication connections 420 such as a network interface card or a USB connection. The one or more user input devices 416 can be a touch screen and a stylus and the like. The one or more output devices 418 can be a display device of computer, computer monitor, TV screen, plasma display, LCD display, display on a touch screen, display on an electronic tablet, and the like. The computer 410 may operate in a networked environment using the communication connection 420 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 404 may include volatile memory 406 and non-volatile memory 408. A variety of computer-readable media may be stored in and accessed from the memory elements of computer 410, such as volatile memory 406 and non-volatile memory 408, removable storage 412 and non-removable storage 414. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like, chemical storage, biological storage, and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 402 of the computer 410. For example, a computer program 425 may include machine-readable instructions capable of handling fixed codeword search according to the teachings of the described embodiments of the present subject matter. In one embodiment, the computer program 425 may be included on a CD-ROM and loaded from the CD-ROM to a hard drive in non-volatile memory 408. The machine-readable instructions cause the computer 410 to decode according to the various embodiments of the present subject matter.

The foregoing is the description of exemplary implementations of the method for fixed codebook search in a manner as to improve the time efficiency of the innermost loop by the use of parallel data paths in the processor. This will assist the deployment of higher performance algorithms that might require relatively more time. The above-described implementation is intended to be applicable, without limitation, to situations where search in algebraic CELP coders using a codebook search is involved. The description hereinabove is intended to be illustrative, and not restrictive.

The various embodiments of the algebraic CELP encoder codebook search described herein are applicable generally to any speech communication system, and the embodiments described herein are in no way intended to limit the applicability of the invention. In addition, the techniques of the various exemplary embodiments are useful to the design of any hardware implementations of software, firmware, and algorithms in the context of decoding in general. Many other embodiments will be apparent to those skilled in the art. The scope of this invention should therefore be determined by the appended claims as supported by the text, along with the full scope of equivalents to which such claims are entitled.

1. A method for performing a codebook search in an algebraic code-excited linear prediction (ACELP) encoder using multiple data paths, comprising the steps of:
using a nested loop structure and as many loops as there are pulses, said loop structure including an innermost loop;
increasing efficiency of the innermost loop by grouping valid pulse positions into subsets and using said multiple data paths; and,
selecting a best pulse position from each of said subsets to find a most beneficial code vector for performing the codebook search.

2. The codebook search method as in claim 1, including conducting a second search among best pulse positions corresponding to the innermost loop, to arrive at a final best pulse position for the code vector.

3. The codebook search method as in claim 1, using a processor with multiple data paths and, including the step of reducing a number of search operations in the innermost loop by reducing a number of search cycles.

4. The codebook search method as in claim 3, wherein the codebook search is a fixed codebook search, wherein the search in each of said subsets is done in parallel by using said multiple processor data paths.

5. The codebook search method as in claim 1, including the step of obtaining parallelism by using different data paths for each of said subsets.

6. The codebook search method as in claim 1, as applied to speech coder standard ITU-T G. 729.

7. The codebook search method as in claim 1, as applied to speech coder standard ITU-T G. 723.1.

8. The method as in claim 1, wherein the codebook search is a fixed codebook search, as applied to GSM adaptive multi-rate WB.

9. An article including a computer readable medium having a program which when executed results in a method for performing a codebook search in an algebraic code-excited linear prediction (ACELP) encoder using a processor having multiple data paths, comprising the steps of:
using a nested loop structure and as many loops as there are pulses, said loop structure including an innermost loop;
increasing efficiency of the innermost loop by grouping pulse positions into subsets and using said processor multiple paths; and,
selecting a best pulse position from each of said subsets to find a most beneficial code vector for performing the fixed codebook search.

10. A method for performing a fixed codebook search in an algebraic code-excited linear prediction (ACELP) encoder using a processor with multiple data paths, comprising the steps of:
using a nested loop structure and as many loops as there are pulses, said loop structure including an innermost loop;
increasing efficiency of the innermost loop by grouping valid pulse positions into subsets and using said multiple data paths;
selecting a best pulse position from search in each of said subsets to find a most beneficial code vector for performing the codebook search,
the method including conducting a second search among best pulse positions corresponding to the innermost loop to arrive at a final best position, further including the step of reducing time required for executing said innermost loop.

11. The codebook search method as in claim 10, including the step of choosing pulse positions.

12. The codebook search method as in claim 11, including the step of using as many loops as the chosen pulse positions, said as many loops including an innermost loop.

13. The codebook search method as in claim 12, including the step of optimizing said innermost loop.

14. The codebook search method as in claim 11, wherein the search in each of said subsets is done in parallel by using different processor data paths.

15. The codebook search method as in claim 11, wherein the number of pulse positions is “4”, and wherein said processor comprises two data paths, including the step of selecting a best pulse position from each of said subsets.

16. The codebook search method as in claim 15, applied to a speech coder conforming to standards and using algebraic code excited linear prediction (ACELP).

17. The codebook search method as in claim 13, as applied to speech coder standard ITU-T G. 729.

18. The codebook search method as in claim 13, as applied to speech coder standard ITU-T G. 723.1.

19. The codebook search method as in claim 13, as applied to GSM adaptive multi-rate WB.

20. The codebook search method as in claim 1, wherein the number of loops is four, including a step where search is done in parallel and simultaneously, reducing time required for executing an innermost loop.

21. An article including a computer readable medium having a program thereon which when executed results in a method for performing a codebook search in an algebraic code-excited linear prediction (ACELP) encoder using multiple data paths, comprising the steps of:
using a nested loop structure and as many loops as there are pulses, said loop structure including an innermost loop;
increasing efficiency of the innermost loop by grouping valid pulse positions into subsets and using said multiple data paths; and,
selecting a best pulse position from each of said subsets to find a most beneficial code vector for performing the codebook search.

22. An article as in claim 21, wherein the codebook search is a fixed codebook search, wherein the search in each of said subsets is done in parallel by using said multiple processor data paths.

23. An article as in claim 21, wherein the codebook search method is as applied to one of standards ITU-T G. 729, and ITU-T G. 723.1.

24. An article as in claim 21, wherein the codebook search method is as applied to GSM adaptive multi-rate-WB.

25. An article including a computer readable medium having a program thereon which when executed results in a method for performing a fixed codebook search in an algebraic code-excited linear prediction (ACELP) encoder using a processor with multiple data paths, comprising the steps of:
using a nested loop structure and as many loops as there are pulses, said loop structure including an innermost loop;
increasing efficiency of the innermost loop by grouping valid pulse positions into subsets and using said multiple data paths;
selecting a best pulse position from search in each of said subsets to find a most beneficial code vector for performing the codebook search, the method including conducting a second search among best pulse positions corresponding to the innermost loop to arrive at a final best position, further including the step of reducing time required for executing said innermost loop.
